(19) United States
(12) Patent Application Publication
(10) Pub. No.: US 2013/0057868 A1
(43) Pub. Date: Mar. 7, 2013

(54) OPTICAL SENSOR, IMAGE FORMING APPARATUS AND DETERMINATION METHOD

(71) Applicants: Yoshihiro OBA, Sendai-shi (JP); Satoru Sugawara, Sendai-shi (JP); Toshihiro Ishii, Sendai-shi (JP); Fumikazu Hoshi, Sendai-shi (JP)

(72) Inventors: Yoshihiro OBA, Sendai-shi (JP); Satoru Sugawara, Sendai-shi (JP); Toshihiro Ishii, Sendai-shi (JP); Fumikazu Hoshi, Sendai-shi (JP)

(21) Appl. No.: 13/603,861

(22) Filed: Sep. 5, 2012

(30) Foreign Application Priority Data
Sep. 5, 2011 (JP) 2011-192440

(51) Int. Cl. G01N 21/55

(52) U.S. Cl. 356/445

(57) ABSTRACT

An optical sensor includes a first illuminating system, a second illuminating system, a first regular reflected light detection system, a second regular reflected light detection system and so forth. The first illuminating system is disposed at the −X side of the opening in the dark box, and the second illuminating system is disposed at the +X side of the opening in the dark box. The first and second illuminating systems emit light to the opening. The incidence angles of irradiation light from the first and second illuminating systems relative to the surface of the stage are set equal to each other. The first regular reflected light detection system detects the light emitted from the first illuminating system and regularly reflected by the recording paper, and the second regular reflected light detection system detects the light emitted from the second illuminating system and regularly reflected by the recording paper.

### CROSS REFERENCE TO RELATED APPLICATION

This application is based on and claims the priority benefit of Japanese Patent Application No. 2011-192440, filed on Sep. 5, 2011, the disclosure of which is incorporated herein by reference in its entirety.

### BACKGROUND OF THE INVENTION

1. Field of the invention

The present invention relates to an optical sensor, an image forming apparatus and a determination method, and more specifically relates to an optical sensor suitable to identify an object, an image forming apparatus including the optical sensor, and a determination method for determining a type of paper by using the optical sensor.

2. Description of the Related Art

In a so-called electrophotographic image forming apparatus such as a digital copier and a laser printer, a toner image is transferred to a recording medium such as recording paper, and then the recording medium is heated and pressurized under predetermined conditions to fix the toner image on the recording medium. In this case, for high-quality image formation, the conditions for fixing the toner image need to be appropriately set according to the type of the recording medium.

Japanese Patent Application Publication No. 2002-340518 discloses a surface nature identification apparatus including a sensor to identify the nature of a surface of a recording material by scanning the surface of the recording material while in contact therewith.

Japanese Patent Application Publication No. 2003-292170 discloses a printer configured to determine a type of paper from a pressure value that a pressure sensor detects after coming into contact with the paper.

Japanese Patent Application Publication No. 2005-156380 discloses a recording material determination apparatus for determining a type of a recording material using reflected light and transmitted light.

Japanese Patent Application Publication No. Hei 10-160687 discloses a sheet material determination apparatus for determining a sheet material in motion based on the amount of light reflected from the surface of the sheet material and the amount of light transmitted through the sheet material.

Japanese Patent Application Publication No. 2006-062842 discloses an image forming apparatus having determination means for determining whether or not there is a recording material housed in a paper feed unit and whether or not the paper feed unit is present, based on a detection output from a reflective optical sensor.

Japanese Patent Application Publication No. Hei 11-249353 discloses an image forming apparatus for determining the surface nature of a recording medium by detecting amounts of two polarization components of light reflected from a recording medium irradiated with light.

However, each of the foregoing conventional apparatuses does not necessarily have stable and sufficient identification accuracy.

### SUMMARY OF THE INVENTION

It is an objective of the present invention to provide an optical sensor capable of accurately and stably identifying an object.

To achieve the foregoing objective, an optical sensor according to one embodiment of the present invention includes a first illuminating system for emitting light onto a surface of an object from a first direction, a second illuminating system for emitting light onto the surface of the object from a second direction different from the first direction, a first regular reflected light receiving system for receiving light emitted from the first illuminating system and regularly reflected by the object, and a second regular reflected light receiving system for receiving light emitted from the second illuminating system and regularly reflected by the object. The object is placed on a flat surface, and incidence angles of the light emitted from the first and second illuminating systems relative to the flat surface are set equal to each other.

### BRIEF DESCRIPTION OF THE DRAWINGS

FIG. 1 is a schematic view showing a configuration of a color printer according to one embodiment of the present invention.

FIG. 2 is a partial cross-sectional view schematically showing a configuration of an optical sensor in FIG. 1.

FIG. 3 is a schematic view showing the configuration of the optical sensor in FIG. 1.

FIG. 4 is a schematic view showing a surface-emitting laser array.

FIGS. 5A and 5B are schematic views for explaining incidence angles of irradiation light relative to a stage surface.

FIG. 6 is a view for explaining a first measurement system.

FIG. 7 is a view for explaining a second measurement system.

FIG. 8A is a schematic view for explaining surface regular reflected light, FIG. 8B is a schematic view for explaining surface diffuse reflected light, and FIG. 8C is a schematic view for explaining internal diffuse reflected light.

FIG. 9 is a view for explaining a shift in illumination region.

FIG. 10 is a view for explaining a tilt of the illumination region.

FIG. 11 is a view for explaining Modified Example 1 of the optical sensor.

FIG. 12 is a view for explaining Modified Example 2 of the optical sensor.

FIG. 13 is a view for explaining Modified Example 3 of the optical sensor.

FIG. 14 is a view for explaining Modified Example 3 of the optical sensor.

FIG. 15 is a view for explaining Modified Example 4 of the optical sensor.

FIG. 16 is a view for explaining Modified Example 4 of the optical sensor.

FIG. 17 is a view for explaining a recording paper determination table.

FIG. 18 is a view for explaining the effect of tilt correction.

FIG. 19 is a view for explaining Modified Example 5 of the optical sensor.

FIG. 20 is a view for explaining Modified Example 5 of the optical sensor.

FIG. 21 is a view for explaining a relationship between the amount of internal diffuse reflected light and the thickness of the recording paper.

FIG. 22 is a view for explaining a relationship between the amount of internal diffuse reflected light and the density of the recording paper.

FIG. 23 is a view for explaining Modified Example 6 of the optical sensor.

FIG. 24 is a view for explaining Modified Example 6 of the optical sensor.

FIGS. 25A to 25C are views for explaining a relationship between the incident direction of light and the reflected light when the recording paper has a uniaxially-oriented concavo-convex structure on its surface.

FIGS. 26A and 26B are views for explaining a relationship between the incident direction of light and the reflected light when the recording paper has a uniaxially-oriented concavo-convex structure on its surface.

### DETAILED DESCRIPTION OF THE PREFERRED EMBODIMENTS

Preferred embodiment of the present invention will be explained hereinafter in detail with reference to the accompanying drawings.

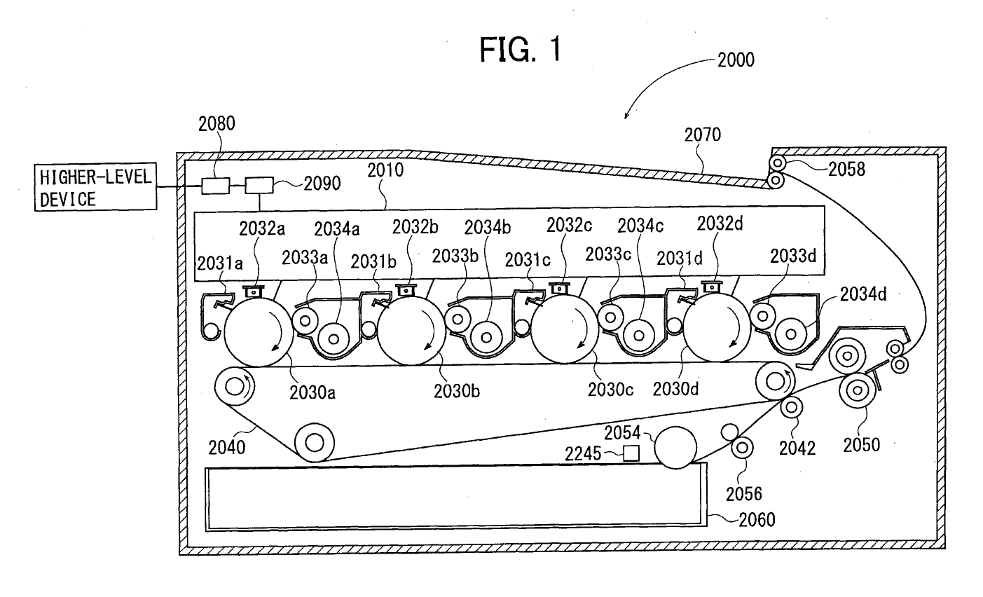

FIG. 1 illustrates a schematic configuration of a color printer 2000 according to one embodiment.

The color printer 2000 is a tandem multi-color printer to form full-color images by combining four colors (black, cyan, magenta and yellow).

The color printer 2000 includes an optical scanning device 2010, four photosensitive drums (2030a, 2030b, 2030c and 2030d), four cleaning units (2031a, 2031b, 2031c and 2031d), four charging devices (2032a, 2032b, 2032c and 2032d), four developing rollers (2033a, 2033b, 2033c and 2033d), four toner cartridges (2034a, 2034b, 2034c and 2034d), a transfer belt 2040, a transfer roller 2042, a fixing device 2050, a feed roller 2054, a discharge roller 2058, a feed tray 2060, a discharge tray 2070, a communication controller 2080, an optical sensor 2245, a printer controller 2090 configured to perform overall control of those described above, and so forth.

The communication controller 2080 controls two-way communication between the printer and a higher-level device (e.g., a personal computer) through a network and the like.

The printer controller 2090 includes a CPU, a ROM storing programs described in a code that can be decoded by the CPU and various data used to execute the programs, a RAM that is a working memory, an AD converter circuit to convert analog data into digital data, and the like. The printer controller 2090 controls the respective parts in response to requests from the higher-level device, and sends image information from the higher-level device to the optical scanning device 2010.

The photosensitive drum 2030a, the charging device 2032a, the developing roller 2033a, the toner cartridge 2034a and the cleaning unit 2031a are used as a set, and form an image forming station to form a black image (hereinafter, for convenience, referred to as “K station”).

The photosensitive drum 2030b, the charging device 2032b, the developing roller 2033b, the toner cartridge 2034b and the cleaning unit 2031b are used as a set, and form an image forming station to form a cyan image (hereinafter, for convenience, referred to as “C station”).

The photosensitive drum 2030c, the charging device 2032c, the developing roller 2033c, the toner cartridge 2034c and the cleaning unit 2031c are used as a set, and form an image forming station to form a magenta image (hereinafter, for convenience, referred to as “M station”).

The photosensitive drum 2030d, the charging device 2032d, the developing roller 2033d, the toner cartridge 2034d and the cleaning unit 2031d are used as a set, and form an image forming station to form an yellow image (hereinafter, for convenience, referred to as “Y station”).

Each of the photosensitive drums has a photosensitive layer formed on its surface. In short, the surface of each of the photosensitive drums serves as a surface to be scanned. The photosensitive drums rotate in the directions indicated by the arrows in FIG. 1 with a rotation mechanism (not shown).

Each of the charging devices uniformly charges the surface of the corresponding photosensitive drum.

The optical scanning device 2010 scans the surface of each charged photosensitive drum with a light beam modulated for the corresponding color based on multi-color image information (black image information, cyan image information, magenta image information, and yellow image information) received from the printer controller 2090. Thus, a latent image corresponding to the image information is formed on the surface of each of the photosensitive drums. The formed latent image is transported toward the corresponding developing roller along with the rotation of the photosensitive drum.

Along with the rotation of each developing roller, the toner from the corresponding toner cartridge is applied to the surface of the developing roller in a thin, uniform manner. When the toner on the surface of each developing roller comes in contact with the surface of the corresponding photosensitive drum, the toner is transferred only to the areas on the surface irradiated with light and adheres to those areas. In other words, each of the developing rollers visualizes an image by depositing toner onto the latent image formed on the surface of the corresponding photosensitive drum. The image visualized as a result of toner being deposited thereonto (the toner image) is transported toward the transfer belt 2040 along with the rotation of the photosensitive drum.

The yellow, magenta, cyan and black toner images are sequentially transferred onto the transfer belt 2040 with a predetermined timing and overlaid with one another to form a multi-color image.

The feed tray 2060 stores recording paper. Near the feed tray 2060 is the feed roller 2054, which takes the recording paper out of the feed tray 2060 one at a time. The recording paper is sent toward a gap between the transfer belt 2040 and the transfer roller 2042 with a predetermined timing. As a result, the color image on the transfer belt 2040 is transferred onto the recording paper. Then, the recording paper having the color image transferred thereon is sent to the fixing device 2050.

In the fixing device 2050, heat and pressure are applied to the recording paper having the color image transferred thereon, thereby fixing the toner onto the recording paper. The recording paper having the toner fixed thereon is sent to the discharge tray 2070 via the discharge roller 2058 and is sequentially stacked on the discharge tray 2070.

Each of the cleaning units removes any toner remaining on the surface of the corresponding photosensitive drum (residual toner). The surface of the photosensitive drum from which the residual toner has been removed returns to the position facing the corresponding charging device.

The optical sensor 2245 is used to identify the brand of the recording paper housed in the feed tray 2060, i.e., is used to determine the type of the recording paper.

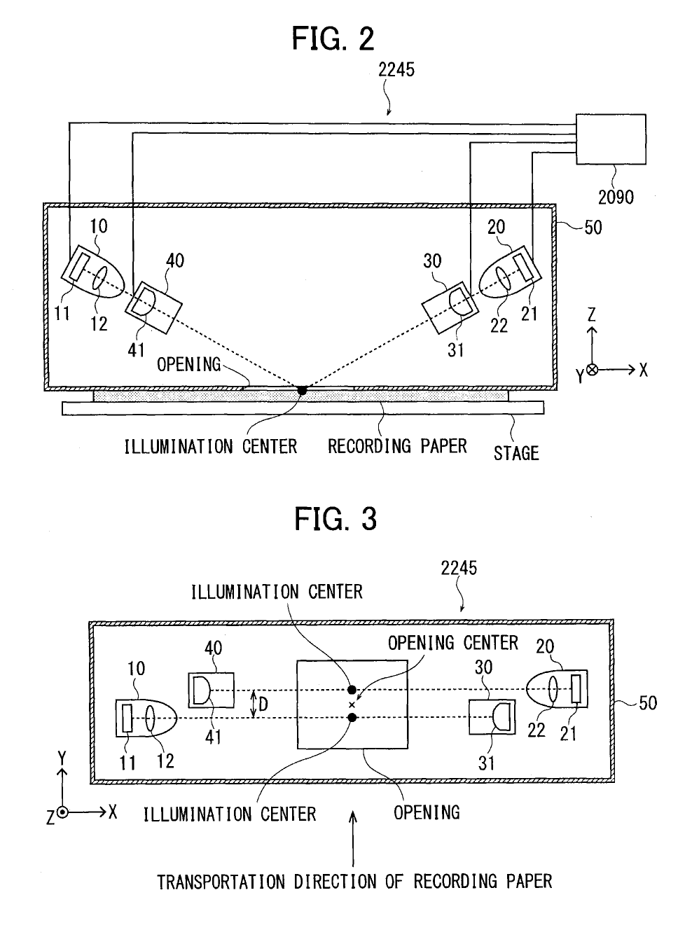

As shown in FIGS. 2 and 3, as an example, the optical sensor 2245 includes a first illuminating system 10, a second illuminating system 20, a first regular reflected light detection system 30, a second regular reflected light detection system 40, a dark box 50 housing these systems, and so forth.

Note that, here, the description is given assuming that a direction orthogonal to the surface of a stage on which the recording paper is placed is a Z-axis direction, and a plane parallel to the surface of the stage is an XY plane in the XYZ three-dimensional Cartesian coordinate system. Moreover, it is also assumed that the optical sensor 2245 is disposed on +Z side of the recording paper, and that the recording paper is transported in the +Y direction.

The dark box 50 is a metal box member, e.g., an aluminum box member, and has its surface subjected to black alumite treatment to reduce the influence of ambient light and stray light. Moreover, the dark box 50 has an opening provided in the center of its plane on −Z side.

The first illuminating system 10 and the first regular reflected light detection system 30 are used as a pair, and hereinafter referred to as the “first measurement system”.

Likewise, the second illuminating system 20 and the second regular reflected light detection system 40 are used as a pair, and hereinafter referred to as the “second measurement system”.

The first illuminating system 10 is disposed at the −X side of the opening in the dark box 50, and includes a light source 11 and a collimator lens 12.

The second illuminating system 20 is disposed at the +X side of the opening in the dark box 50, and includes a light source 21 and a collimator lens 22.

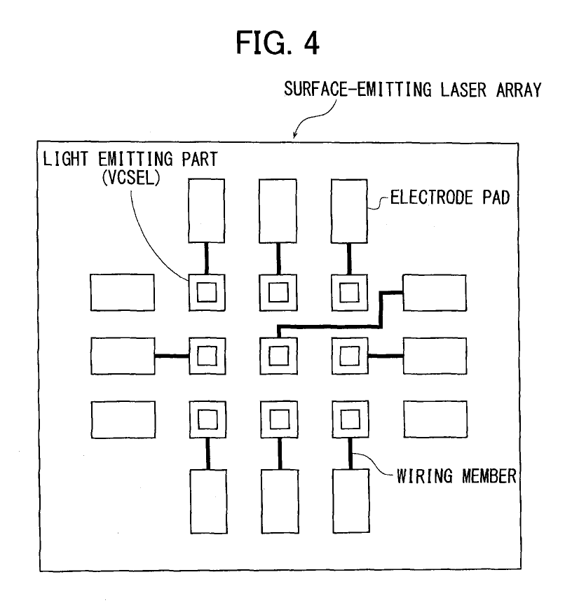

Each of the light sources has a surface-emitting laser array having multiple light emitting parts. Here, as an example, nine light emitting parts are two-dimensionally arranged as shown in FIG. 4.

The multiple light emitting parts of the light sources are individually turned on and off by the printer controller 2090.

The collimator lens 12 is disposed on an optical path of a light beam emitted from the light source 11 to make the light beam approximately parallel light. The light beam through the collimator lens 12 is emitted from the first illuminating system 10.

The first illuminating system 10 is disposed in such a manner that the light beam emitted from the first illuminating system 10 travels to the opening in the dark box 50 by passing in parallel to the X-axis direction when seen from the Z-axis direction, and at angles relative to the X-axis direction and Y-axis direction, respectively, when seen from the Y-axis direction.

The collimator lens 22 is disposed on an optical path of a light beam emitted from the light source 21 to make the light beam approximately parallel light. The light beam through the collimator lens 22 is emitted from the second illuminating system 20.

The second illuminating system 20 is disposed in such a manner that the light beam emitted from the second illuminating system 20 travels to the opening in the dark box 50 by passing in parallel to the X-axis direction when seen from the Z-axis direction, and at angles relative to the X-axis direction and Y-axis direction, respectively, when seen from the Y-axis direction.

In short, the light beam emitted from the first illuminating system 10 and the light beam emitted from the second illuminating system 20 are parallel to each other when seen from the Z-axis direction.

In order to avoid interference, the first and second measurement systems are spaced apart by a distance D in the Y-axis direction.

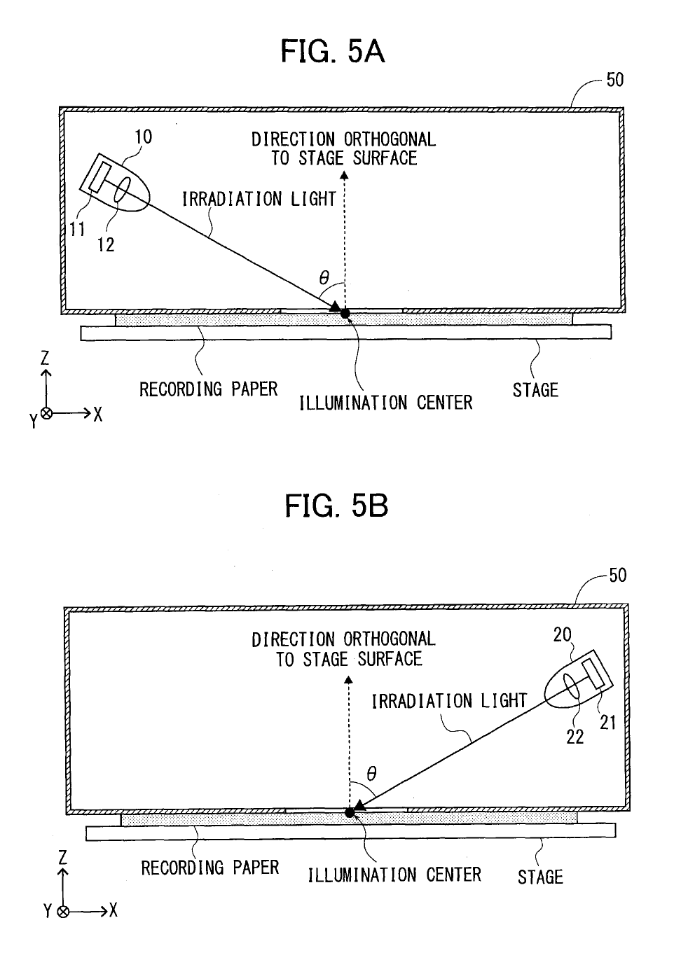

As shown in FIGS. 5A and 5B, the light beam emitted from the first illuminating system 10 and the light beam emitted from the second illuminating system 20 illuminate the recording paper through the opening in the dark box 50.

Note that, hereinafter, the center of the illumination region on the surface of the recording paper is abbreviated as the “illumination center”. Moreover, the light beam emitted from each of the illuminating systems is also referred to as the “irradiation light”.

The incidence angle of the irradiation light from the first illuminating system 10 relative to the surface of the stage and the incidence angle of the irradiation light from the second illuminating system 20 relative thereto are the same incidence angle θ. Here, as an example, θ=80°.

Moreover, the area of the illumination region irradiated with the irradiation light from the first illuminating system 10 and the area of the illumination region irradiated with the irradiation light from the second illuminating system 20 are approximately the same.

The timing of emitting the light beam from the second illuminating system 20 is set later than the timing of emitting the light beam from the first illuminating system 10 based on the transportation speed of the recording paper and the distance D. Thus, the illumination center of the irradiation light from the first illuminating system 10 and the illumination center of the irradiation light from the second illuminating system 20 approximately coincide with each other.

When the light is incident on the boundary plane of the medium, a plane including the incident beam and the normal to the boundary plane at the incident point is called the “incidence plane”. Therefore, when the incident light is composed of multiple light beams, there are incidence planes for respective light beams. However, here, for convenience, the incidence plane of the light beam incident on the illumination center is assumed to be the incidence plane on the recording paper. In other words, the plane including the illumination center and parallel to the XZ plane is the incidence plane on the recording paper.

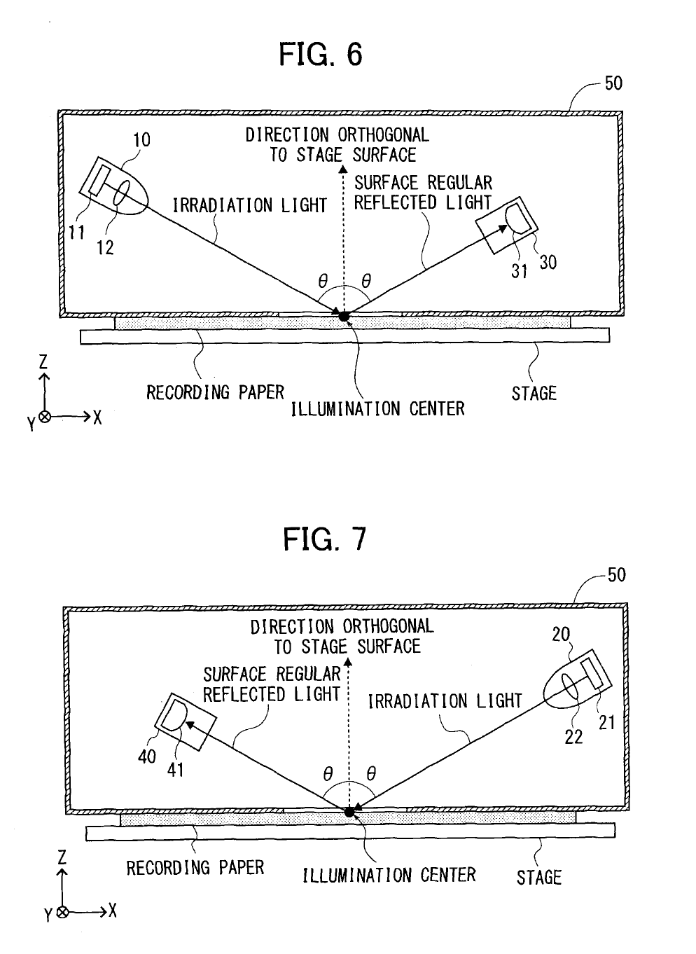

The first regular reflected light detection system 30 has a photodetector 31 including a condenser lens, and is disposed on an optical path of a light beam emitted from the first illuminating system 10 and regularly reflected by the recording paper, as shown in FIG. 6 as an example.

When seen from the Z-axis direction, the first illuminating system 10 and the first regular reflected light detection system 30 are positioned on the same line extending in the X-axis direction.

The second regular reflected light detection system 40 has a photodetector 41 including a condenser lens, and is disposed on an optical path of a light beam emitted from the second illuminating system 20 and regularly reflected by the recording paper, as shown in FIG. 7 as an example.

When seen from the Z-axis direction, the second illuminating system 20 and the second regular reflected light detection system 40 are positioned on the same line extending in the X-axis direction.

An output signal from each photodetector is sent to the printer controller 2090. Hereinafter, a signal level of the output signal from the photodetector 31 is referred to as “S11”, and a signal level of the output signal from the photodetector 41 is referred to as “S21”.

The reflected light from the recording paper when the recording paper is illuminated can be considered as divided into light reflected by the surface of the recording paper and light reflected inside the recording paper. Moreover, the light reflected by the surface of the recording paper can be considered as divided into regular reflected light and diffuse reflected light.

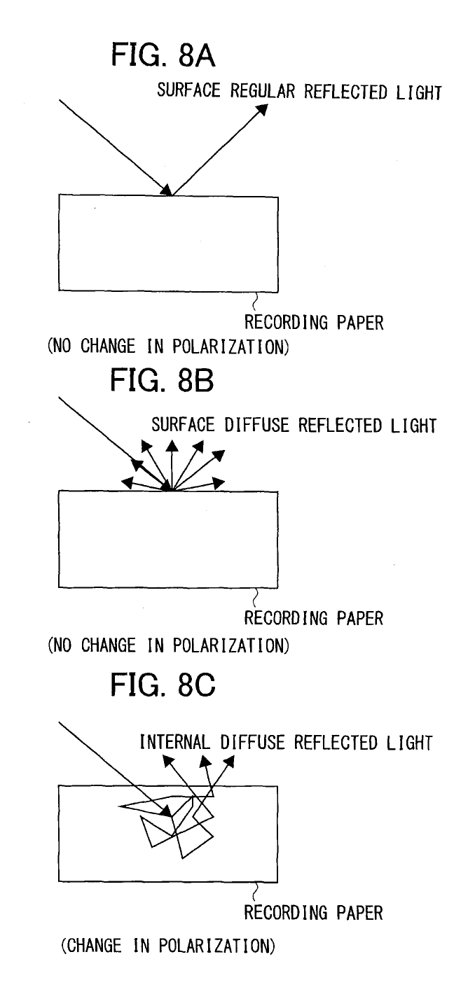

Hereinafter, for convenience, the light regularly reflected by the surface of the recording paper is referred to as the “surface regular reflected light” and the diffuse reflected light is referred to as the “surface diffuse reflected light” (see FIGS. 8A and 8B).

On the other hand, the reflected light from the inside of the recording paper is only the diffuse reflected light, when the recording paper is general printing paper, since the light is multiply-scattered within the fibers of the recording paper. Hereinafter, for convenience, the reflected light from the inside of the recording paper is referred to as the “internal diffuse reflected light” (see FIG. 8C). As in the case of the surface diffuse reflected light, the internal diffuse reflected light is also totally scatter-reflected light, and thus can be regarded as having isotropic reflection direction.

The surface regular reflected light and the surface diffuse reflected light have the same polarization state as that of the incident light. On the other hand, a polarization state of the internal diffuse reflected light is different from that of the incident light. This is considered to be because the light is rotated while being transmitted through the fibers and multiply-scattered, and the polarization direction is rotated.

Meanwhile, on the surface of the recording paper, the region irradiated with the irradiation light (the illumination region) can be shifted in the Z-axis direction from its designed position or can be tilted from the XY plane due to deflection, vibration and the like. Note that the designed recording paper surface parallel to the XY plane is referred to as the “reference plane”.

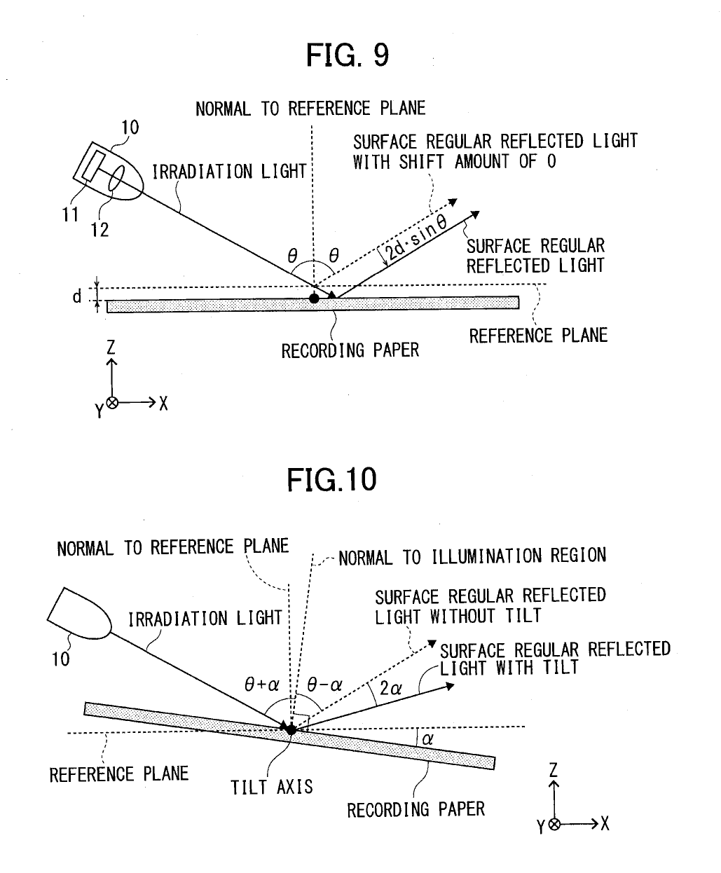

FIG. 9 illustrates the case where the illumination region is shifted by d in the −Z direction from the reference plane. Note that FIG. 9 shows a shift amount in an exaggerated manner for simplicity.

In this case, a position of receiving the surface regular reflected light in the photodetector is shifted by 2d×sinθ when there is no condenser lens.

For example, when the incidence angle θ is 80° and the shift amount d is 1 mm, the shift amount of the light receiving position is about 2 mm. In this case, the following measures can be taken: (a) using a photodiode (PD) having a light receiving region of 2 mm or more as a light receiving element of the photodetector, (b) reducing the beam diameter of the irradiation light so that the beam diameter of the surface regular reflected light is sufficiently reduced compared to 2 mm, and (c) disposing a condenser lens having an aperture of 2 mm or more in front of the light receiving part.

In this event, a PD array having multiple light receiving regions, which amount to 2 mm or more, may be used instead of the photodiode (PD). In this case, even though the light receiving position is shifted, a signal with a maximum level among signals individually outputted from the multiple light receiving regions can be set to be a light receiving signal of the surface regular reflected light. Moreover, the photodiode (PD) has a risk that the output may be changed by the shift in the light receiving position from the center of the light receiving region. Meanwhile, the PD array is free of such a risk since the individual light receiving regions can be reduced, thus enabling more accurate detection.

FIG. 10 illustrates the case where the illumination region is tilted at an angle a around an axis (tilt axis) parallel to the Y-axis direction on the reference plane. Note that FIG. 10 shows the tilt in an exaggerated manner for simplicity. In this case, the incidence angle of the irradiation light relative to the illumination region is θ+α, and the reflectance of the irradiation light in the illumination region is changed compared to the case where the illumination region is not tilted. In short, the output level of the photodetector differs between the case where the illumination region is tilted and the case where the illumination region is not tilted even when the same brand of recording paper is used.

When non-polarized light is regularly reflected, a reflectance change due to the change in the incidence angle is calculated using a Fresnel coefficient R (n, θ) represented by the following Expression (1), where n is a relative refractive index and θ is the incidence angle. In this case, if the incidence angle is changed from 80° to 81°, the reflectance change is about 4%. Here, as the relative refractive index n, 1.53 is used, which is a relative refractive index of light entering cellulose that is a main component of general recording paper from the air.

[symbol]

[Expression 1]

Here, a change in the output level of the photodetector attributable to the reflectance change needs to be corrected. As the correction method, two methods are conceivable.

### (A) First Correction Method

A first correction method is to calculate an average value Save of the signal level S11 of the photodetector 31 and the signal level S21 of the photodetector 41 using the following Expression (2), and then set the Save as a corrected signal level Smod.

Save=(S11+S21)/2 (2)

### (B) Second Correction Method

A second correction method is to obtain a tilt angle of the illumination region from the signal levels S11 and S21, and then correct the signal level based on the tilt angle.

When the illumination region is not tilted, the incidence angle θ, the tilt angle a and the Fresnel coefficient have a relationship represented by the following Expression (3).

[symbol]

[Expression 3]

In this embodiment, a relationship represented by the following

Expression (4) is obtained from the above Expression (3).

[symbol]

[Expression 3]

Using the tilt angle a obtained from the above Expression (4), the corrected signal level Smod is calculated from the following Expression (5).

[symbol]

[Expression 4]

When the illumination region is tilted, the light receiving position of the surface regular reflected light in the photodetector is shifted by L×tan 2α when there is no condenser lens, L being the distance between the illumination center and the photodetector.

For example, when the incidence angle is changed from 80° to 81° with L=30 mm, a shift in the light receiving position is about 1 mm. In this case, the following measures can be taken: (1) using a photodiode (PD) having a light receiving region of 1 mm or more as a light receiving element of the photodetector, (b) reducing the beam diameter of the irradiation light so that the beam diameter of the surface regular reflected light is sufficiently reduced compared to 1 mm, and (c) disposing a condenser lens having an aperture of 1 mm or more in front of the light receiving part. Note that the tilt and shift in the illumination region affect not only the surface regular reflected light but also surface diffuse reflected light and internal diffuse reflected light.

Here, as to multiple types of recording paper compatible with the color printer 2000, the signal level S11 is measured for each type of recording paper in a pre-shipment step such as an adjustment step. Then, based on the measurement result, a “recording paper determination table” is created, in which the range of the signal level S11 including an error range is associated with the recording paper. The created table is stored in the ROM of the printer controller 2090. Note that, in the measurement of the signal level S11, the surface of the recording paper is adjusted to be at the same level as the reference plane. Moreover, the multiple types of recording paper are different from each other in at least one of gloss and smoothness.

Furthermore, as to multiple brands of recording paper compatible with the color printer 2000, optimum developing conditions and transfer conditions at each station are determined for each brand of recording paper in a pre-shipment step such as an adjustment step. Then, the determination result is stored as a “developing/transfer table” in the ROM of the printer controller 2090.

The printer controller 2090 performs a paper type determination process for the recording paper using the optical sensor 2245 when the color printer 2000 is turned on, when the recording paper is fed to the feed tray 2060, and the like. The paper type determination process performed by the printer controller 2090 will be described below.

(1) The multiple light emitting parts of the light source 11 are simultaneously turned on.
(2) A value of the signal level S11 is obtained from an output signal from the photodetector 31.
(3) The multiple light emitting parts of the light source 11 are simultaneously turned off.
(4) After the elapse of time calculated based on the transportation speed of the recording paper and the distance D, the multiple light emitting parts of the light source 21 are simultaneously turned on so that their illumination centers approximately coincide with each other.
(5) A value of the signal level S21 is obtained from an output signal from the photodetector 41.
(6) The multiple light emitting parts of the light source 21 are simultaneously turned off.
(7) A corrected signal level Smod is obtained using the first correction method or second correction method described above.
(8) Referring to the recording paper determination table, the type of recording paper corresponding to the signal level S11 having the same value as the corrected signal level Smod is extracted. This extracted type serves as the specified type of recording paper.
(9) The specified type of recording paper is stored in the RAM, and then the paper type determination process is terminated.

Upon receipt of a print job request from a user, the printer controller 2090 reads the brand of recording paper stored in the RAM, and extracts optimum developing conditions and transfer conditions corresponding to the brand of recording paper from the developing/transfer table.

Thereafter, the printer controller 2090 controls a developing device and a transfer device at each station according to the extracted optimum developing conditions and transfer conditions. The printer controller 2090 controls a transfer voltage or a toner amount, for example. Thus, a high-quality image is formed on the recording paper.

As described above, the color printer 2000 according to this embodiment includes the optical scanning device 2010, the four image forming stations, the transfer belt 2040, the transfer roller 2042, the fixing device 2050, the feed roller 2054, the discharge roller 2058, the feed tray 2060, the discharge tray 2070, the communication controller 2080, the optical sensor 2245, the printer controller 2090 configured to perform overall control of those described above, and so forth.

The optical sensor 2245 includes the first illuminating system 10, the second illuminating system 20, the first regular reflected light detection system 30, the second regular reflected light detection system 40, the dark box 50 housing these systems, and so forth.

The first illuminating system 10 is disposed at the −X side of the opening in the dark box 50, and emits light beams toward the opening. The second illuminating system 20 is disposed at the +X side of the opening in the dark box 50, and emits light beams toward the opening.

The incidence angle of the irradiation light from the first illuminating system 10 relative to the surface of the stage and the incidence angle of the irradiation light from the second illuminating system 20 relative thereto are the same incidence angle θ.

Moreover, the area of the illumination region irradiated with the irradiation light from the first illuminating system 10 and the area of the illumination region irradiated with the irradiation light from the second illuminating system 20 are approximately the same.

The first regular reflected light detection system 30 has the photodetector 31 including a condenser lens, and is disposed on an optical path of a light beam emitted from the first illuminating system 10 and regularly reflected by the recording paper. The second regular reflected light detection system 40 has the photodetector 41 including a condenser lens, and is disposed on an optical path of a light beam emitted from the second illuminating system 20 and regularly reflected by the recording paper.

In the paper type determination process for the recording paper, the printer controller 2090 corrects the influence of the reflectance change attributable to the tilt in the illumination region, based on the output signals from the photodetectors 31 and 41.

Accordingly, the paper type determination for the recording paper can be accurately performed even when the illumination region is tilted from the reference plane due to deflection, vibration and the like of the recording paper.

Moreover, since the illumination center of the irradiation light from the first illuminating system 10 and the illumination center of the irradiation light from the second illuminating system 20 approximately coincide with each other, the influence of the unevenness on the surface of the recording paper can be reduced.

Moreover, since each of the light sources has a surface-emitting laser array having multiple light emitting parts, speckle noise can be reduced, and the S/N ratio can be improved with the increased amount of irradiation light. Furthermore, since the irradiation light can be easily set to be parallel light, light use efficiency is improved, thereby enabling a stable signal level of the output signal from the photodetector.

Note that although the description was given of the case where the surface-emitting laser array has nine light emitting parts in the embodiment described above, the present invention is not limited thereto.

In the embodiment described above, the optical sensor 2245 may have a processing device to perform at least some of the processing performed by the printer controller 2090 in the paper type determination process for the recording paper.

### <Modified Example 1 of Optical Sensor>

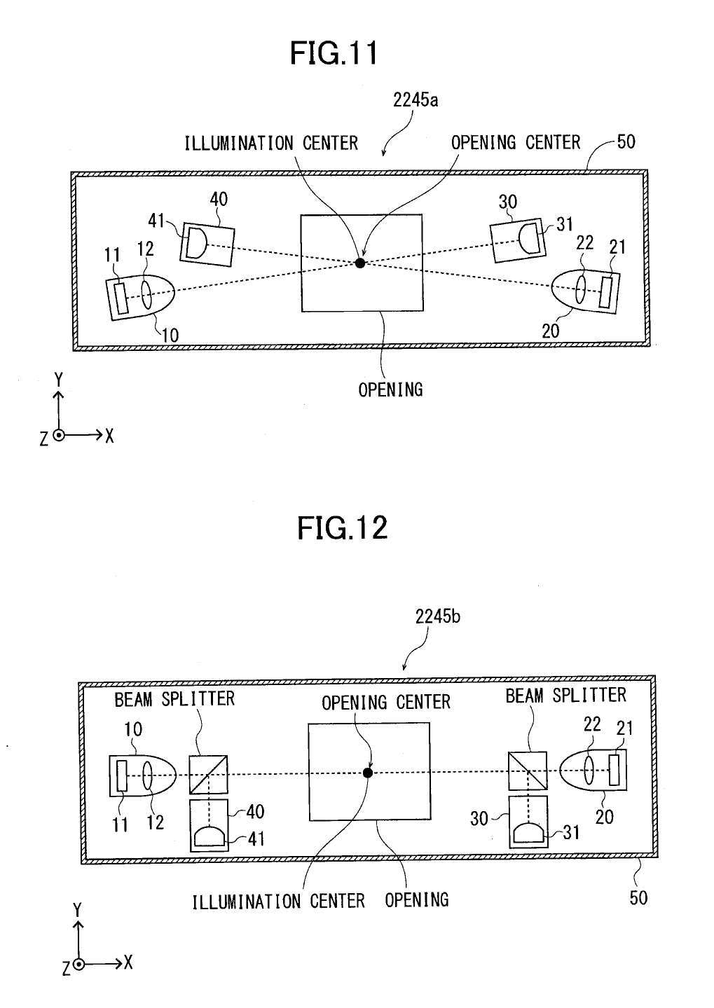

FIG. 11 shows an optical sensor (hereinafter referred to as the “optical sensor 2245a”) of Modified Example 1. This optical sensor 2245a is obtained by disposing the first measurement system and the second measurement system in a non-parallel manner when seen from the Z-axis direction in the optical sensor 2245. In this case, on the stopped recording paper, the illumination center of the irradiation light from the first illuminating system 10 and the illumination center of the irradiation light from the second illuminating system 20 can be set to approximately coincide with each other. Thus, the multiple light emitting parts of the first illuminating system 10 and the multiple light emitting parts of the second illuminating system 20 can be simultaneously turned on.

### <Modified Example 2 of Optical Sensor>

FIG. 12 shows an optical sensor (hereinafter referred to as the “optical sensor 2245b”) of Modified Example 2. This optical sensor 2245b is obtained by disposing a beam splitter in front of each illuminating system in the optical sensor 2245 and branching the regular reflected light. In this case, when seen from the Z-axis direction, an optical path of irradiation light from the first illuminating system 10 and an optical path of irradiation light from the second illuminating system 20 can be set parallel to the X-axis direction, and on the stopped recording paper, the illumination center of the irradiation light from the first illuminating system 10 and the illumination center of the irradiation light from the second illuminating system 20 can be set to approximately coincide with each other.

### <Modified Example 3 of Optical Sensor>

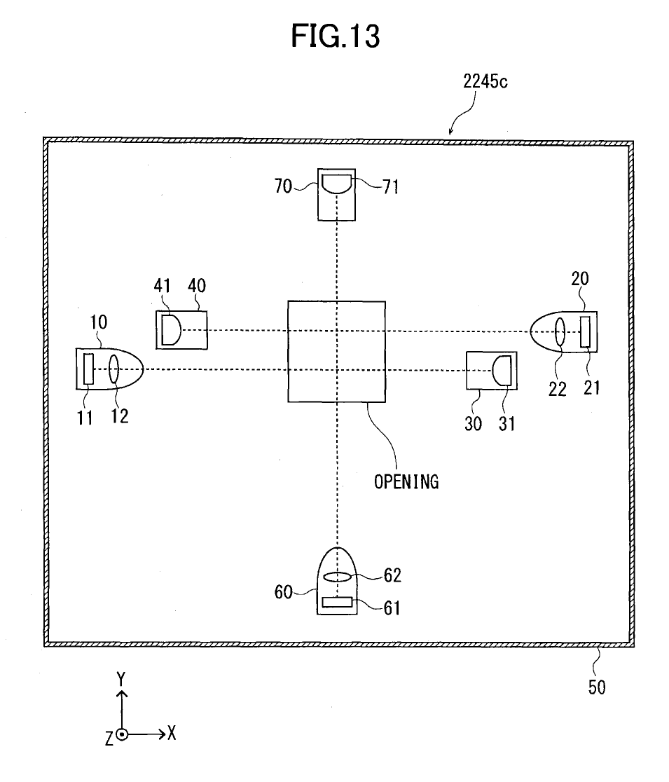

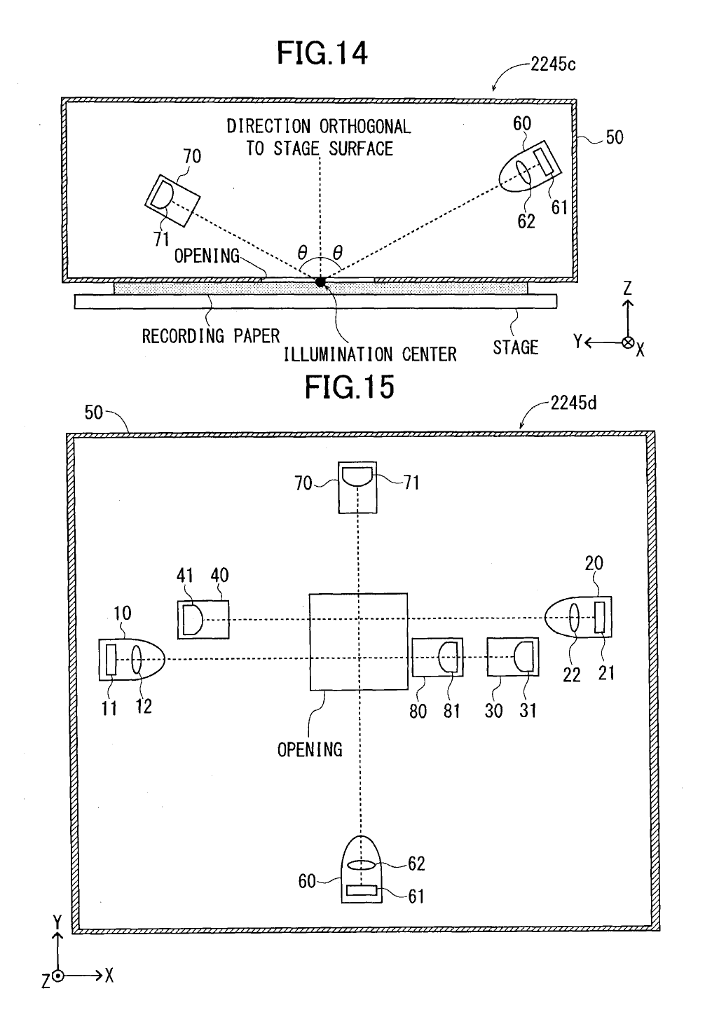

FIGS. 13 and 14 show an optical sensor (hereinafter referred to as the “optical sensor 2245c”) of Modified Example 3. This optical sensor 2245c is obtained by adding a third measurement system including a third illuminating system 60 and a third regular reflected light detection system 70 to the optical sensor 2245. Note that FIG. 14 omits the illustration of the first and second measurement systems to avoid complication.

The third illuminating system 60 includes a light source 61 and a collimator lens 62, is disposed at the −Y side of the opening in the dark box 50, and emits light beams toward the opening.

The incidence angle of irradiation light from the third illuminating system 60 relative to the surface of the stage is the incidence angle θ, which is the same as the incidence angle of the irradiation light from the first illuminating system 10 and the incidence angle of the irradiation light from the second illuminating system 20.

Moreover, the area of the illumination region irradiated with the irradiation light from the third illuminating system 60 is approximately the same as the area of the illumination region irradiated with the irradiation light from the first illuminating system 10 and the area of the illumination region irradiated with the irradiation light from the second illuminating system 20.

Furthermore, the illumination center of the irradiation light from the third illuminating system 60 is set as close as possible to the illumination center of the irradiation light from the first illuminating system 10 and the illumination center of the irradiation light from the second illuminating system 20.

The third regular reflected light detection system 70 has a photodetector 71 including a condenser lens, and is disposed on an optical path of a light beam emitted from the third illuminating system 60 and regularly reflected by the recording paper. Hereinafter, a signal level of an output signal from the photodetector 71 is referred to as “S31”.

When seen from the Z-axis direction, the third illuminating system 60 and the third regular reflected light detection system 70 are positioned on the same line extending in the Y-axis direction.

The multiple light emitting parts of the light source 61 are individually turned on and off by the printer controller 2090. The output signal from the photodetector 71 is sent to the printer controller 2090.

In this case, in the first correction method described above, the following Expression (6) is used instead of the above Expression (2) to obtain an average value Save of the signal level S11 of the photodetector 31, the signal level S21 of the photodetector 41 and the signal level S31 of the photodetector 71 as a corrected signal level Smod.

Save=(S11+S21+S31)/3 (6)

On the other hand, in the second correction method described above, the following Expressions (7) to (12) are used instead of the above Expression (4), and the following Expression (13) is used instead of the above Expression (5).

[symbol]

[Expression 5]

For generalization, assuming that the number of measurement systems is N, the signal level of the photodetector in the i-th measurement system is Si1, and the signal level of the photodetector in the j (≠i)-th measurement system is Sj1, the following Expression (14) is used instead of the above Expression (2) in the first correction method, and the following Expression (15) is used instead of the above Expression (4) and the following Expression (16) is used instead of the above Expression (5) in the second correction method. Note that i=1 to N, j=1 to N, and i≠j in Expression (15).

[symbol]

[Expression 6]

In this case, even if the illumination region is further tilted around the axis (tilt axis) parallel to the X-axis direction on the reference plane, the influence of the tilt can be corrected.

Note that the first and second measurement systems may be equivalent to the optical sensor 2245a or the optical sensor 2245b.

### <Modified Example 4 of Optical Sensor>

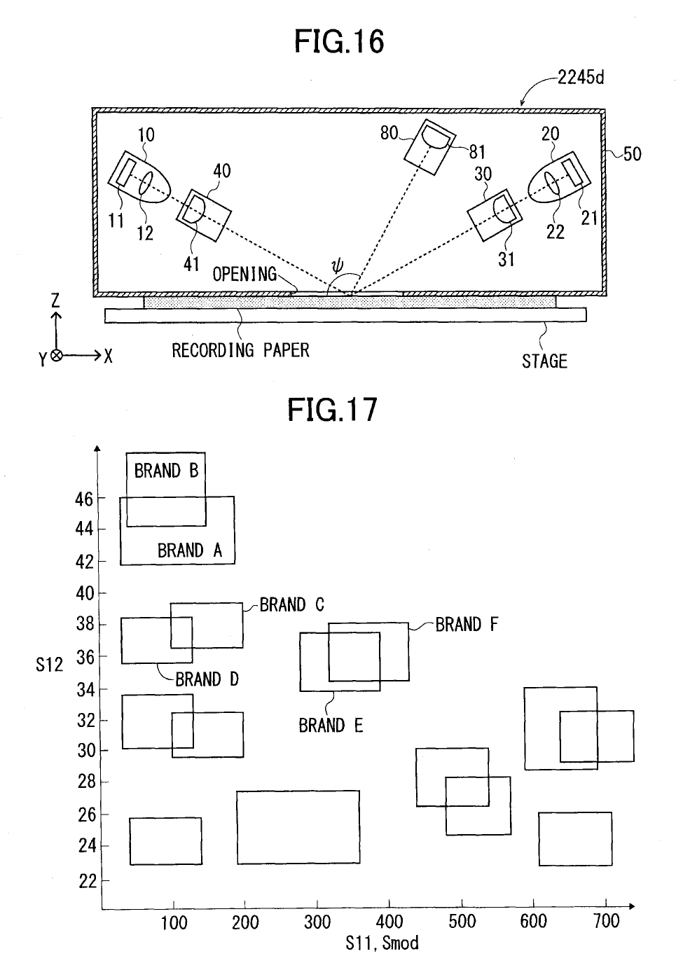

FIGS. 15 and 16 show an optical sensor 2245d of Modified Example 4. This optical sensor 2245d is obtained by adding a diffuse reflected light detection system 80 to the optical sensor 2245c. Note that FIG. 16 omits the illustration of the third measurement system to avoid complication.

When seen from the Z-axis direction, the first illuminating system 10, the second illuminating system 20 and the first regular reflected light detection system 30 are positioned on the same line extending in the X-axis direction.

The diffuse reflected light detection system 80 has a photodetector 81 including a condenser lens, and is disposed on an optical path of a light beam emitted from the first illuminating system 10 and diffuse-reflected by the recording paper. Here, the symbol ψ in FIG. 16 indicates 120°. The photodetector 81 is configured to detect synthetic light of surface diffuse reflected light and internal diffuse reflected light of the light irradiated onto the recording paper from the first illuminating system 10. An output signal from the photodetector 81 is sent to the printer controller 2090. Note that a signal level of the output signal from the photodetector 81 is referred to as “S12”.

In this case, as to multiple types of recording paper compatible with the color printer 2000, values of S11 and S12 are measured for each type of recording paper in a pre-shipment step such as an adjustment step. Then, the measurement result is stored as a “recording paper determination table” in the ROM of the printer controller 2090. FIG. 17 illustrates the recording paper determination table.

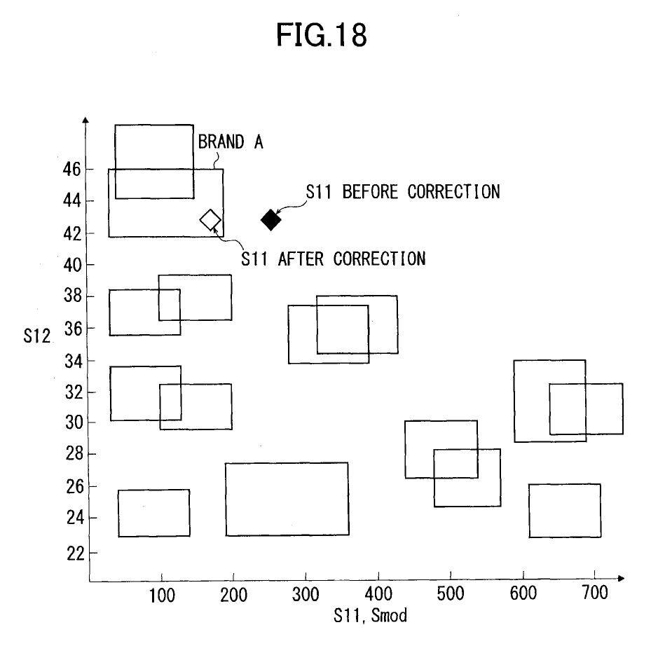

FIG. 18 shows positions corresponding to S11 and S12 before the first or second correction in the recording paper determination table, and positions corresponding to Smod and S12 obtained by the first or second correction. While the brand of the recording paper cannot be specified by S11 and S12 before the correction, the recording paper is specified as Brand A by the correction.

With the optical sensor 2245d, the brand of the recording paper can be more accurately determined compared with the embodiment described above.

Note that although the diffuse reflected light detection system is added only to one measurement system in the optical sensor 2245d, the diffuse reflected light detection system may be added to more than one measurement system.

The first and second measurement systems may be equivalent to the optical sensor 2245a or the optical sensor 2245b.

Moreover, the diffuse reflected light detection system 80 may be added to the optical sensor 2245.

### <Modified Example 5 of Optical Sensor>

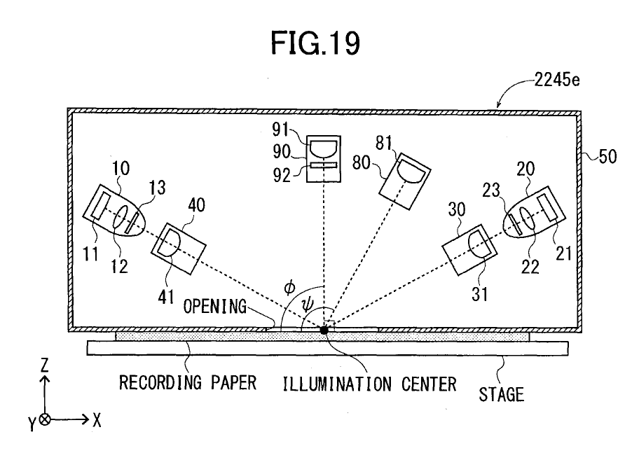

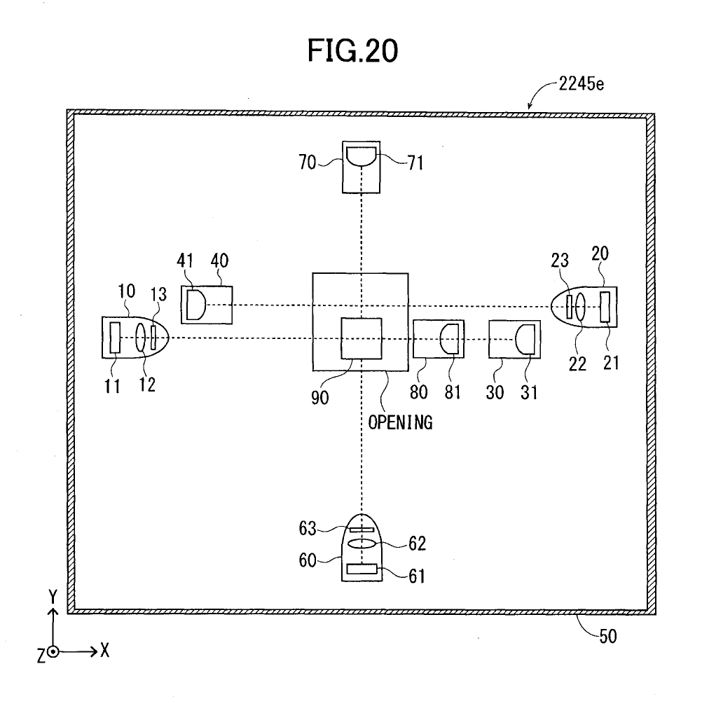

FIGS. 19 and 20 show an optical sensor 2245e of Modified Example 5.

This optical sensor 2245e is obtained by adding an internal diffuse reflected light detection system 90 to the optical sensor 2245d. Moreover, a polarization element is added to each illuminating system. Note that FIG. 19 omits the illustration of the third measurement system to avoid complication.

The first illuminating system 10 has a polarization element 13 to linearly polarize the light beam through the collimator lens 12 in a first polarization direction.

The second illuminating system 20 has a polarization element 23 to linearly polarize the light beam through the collimator lens 22 in the first polarization direction.

The third illuminating system 60 has a polarization element 63 to linearly polarize the light beam through the collimator lens 62 in the first polarization direction. The internal diffuse reflected light detection system 90 is disposed on the +Z side of the illumination center, and includes a polarization filter 92 transmitting a linearly polarized light in a second polarization direction orthogonal to the first polarization direction, and a photodetector 91 configured to receive the light beam transmitted through the polarization filter 92 and equipped with a condenser lens. An output signal from the photodetector 91 is sent to the printer controller 2090. Note that a signal level of the output signal from the photodetector 91 is hereinafter referred to as “S13”.

Here, it is assumed that the linear polarization in the first polarization direction is s-polarization, and the linear polarization in the second polarization direction is p-polarization. Note that the first polarization direction is parallel to the reference plane. The symbol Φ in FIG. 19 represents approximately 90°.

In this case, the Fresnel coefficient R (n, θ) is obtained by the following Expression (17).

[symbol]

[Expression 7]

Note that when the linear polarization in the first polarization direction is p-polarization, the Fresnel coefficient R (n, θ) is obtained by the following Expression (18).

[symbol]

[Expression 18]

When seen from the Z-axis direction, the first illuminating system 10, the first regular reflected light detection system 30, the diffuse reflected light detection system 80 and the internal diffuse reflected light detection system 90 are positioned on the same line extending in the X-axis direction.

The polarization directions of the surface regular reflected light and the surface diffuse reflected light are the same as the polarization direction of the incident light. For the polarization direction to be rotated on the surface of the recording paper, the incident light needs to be reflected by the plane tilted from the optical axis in the direction of the rotation. Here, since the center of the light source, the illumination center and the center of each photoreceiver are on the same plane, the reflected light having the polarization direction rotated on the surface of the recording paper is not reflected toward any photoreceiver.

On the other hand, the polarization direction of the internal diffuse reflected light is rotated in the polarization direction of the incident light. This is considered to be because the light is rotated while being transmitted through the fibers and multiply-scattered, and the polarization direction is rotated.

When the light is emitted from the first illuminating system 10, surface diffuse reflected light and internal diffuse reflected light are made incident on the polarization filter 92. Since the polarization direction of the surface diffuse reflected light is the same as that of the incident light, the surface diffuse reflected light is blocked by the polarization filter 92.

On the other hand, the polarization direction of the internal diffuse reflected light is rotated from that of the incident light, p-polarization components contained in the internal diffuse reflected light are transmitted through the polarization filter 92. In other words, the p-polarization components contained in the internal diffuse reflected light are received by the photodetector 91.

It has been confirmed by the inventors that the amount of the p-polarization components contained in the internal diffuse reflected light is correlated to the thickness or density of the recording paper. This is because the amount of the p-polarization components is dependent on the path length when the light passes through the fibers of the recording paper.

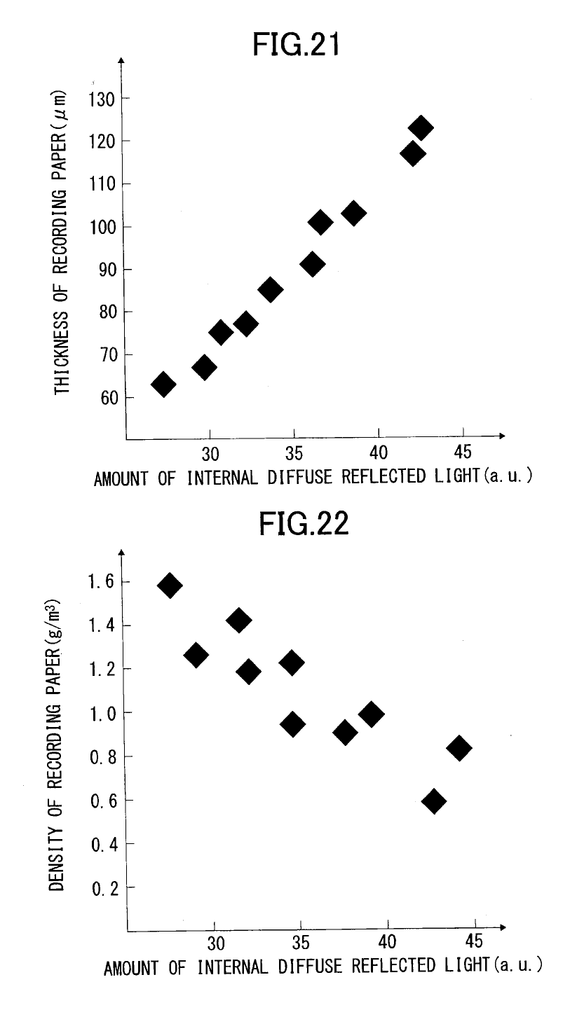

As an example, as shown in FIG. 21, the amount of internal diffuse reflected light and the thickness of the recording paper are correlated to each other, and the thicker the recording paper, the greater the value of the amount of internal diffuse reflected light. Thus, the thickness of the recording paper can be obtained based on the value of the amount of internal diffuse reflected light.

As an example, as shown in FIG. 22, the amount of internal diffuse reflected light and the density of the recording paper are correlated to each other, and the higher the density of the recording paper, the greater the value of the amount of internal diffuse reflected light. Thus, the density of the recording paper can be obtained based on the value of the amount of internal diffuse reflected light.

Note that FIGS. 21 and 22 show results of measurement using multiple kinds of recording paper different in thickness and density.

With the optical sensor 2245e, the brand of the object can be specified among multiple kinds of recording paper different in at least any of gloss, smoothness, thickness and density.

Moreover, with the optical sensor 2245e, criteria (determination criteria) to determine the type of recording paper include (a) the amount of surface regular reflected light, (b) the amount of surface diffuse reflected light and (c) the amount of internal diffuse reflected light, thus allowing for more detailed determination.

In this case, as to multiple types of recording paper compatible with the color printer 2000, values of S11 to S13 are measured for each type of recording paper in a pre-shipment step such as an adjustment step. Then, the measurement result is stored as a “recording paper determination table” in the ROM of the printer controller 2090.

In order to accurately detect the internal diffuse reflected light, it is preferable that light travelling at least in the detection direction does not contain surface regular reflected light components. In an actual illuminating system, it is difficult to emit light only in a totally one direction (first polarization direction). The light reflected by the surface of the recording paper also contains components in the second polarization direction orthogonal to the first polarization direction.

To be more specific, when a photodetector is provided at a position of detecting the surface regular reflected light and the amount of polarization components in the second polarization direction is detected using the polarization filter, if the light irradiated onto the recording paper contains the polarization components in the second polarization direction, these polarization components are also detected by the photodetector, leading to reduction in detection accuracy for the amount of the internal diffuse reflected light.

Since there is a small amount of internal diffuse reflected light from the recording paper, the amount of the polarization components in the second polarization direction contained in the light irradiated onto the recording paper may be increased more than the internal diffuse reflected light.

Note that it is also possible to convert the light irradiated onto the recording paper into light completely in the first polarization direction. This, however, requires a polarization filter having a high extinction ratio, resulting in increased cost.

Moreover, in order to accurately detect the internal diffuse reflected light, it is preferable that a photodetector is disposed in a direction approximately orthogonal to the surface of the recording paper. This is because the internal diffuse reflected light can be regarded as total diffuse reflected light, and thus the relationship between the detection direction and the amount of reflected light can be approximated using a Lambertian distribution. That is, the amount of the internal diffuse reflected light is highest in the direction orthogonal to the illumination region.

Since the amount of the internal diffuse reflected light is very small, the S/N ratio can be improved and the detection accuracy for the internal diffuse reflected light can be maximized by disposing a photodetector in the direction approximately orthogonal to the illumination region.

Note that when multiple photodetectors are provided to detect the internal diffuse reflected light, it is preferable that the multiple photodetectors are disposed in the direction approximately orthogonal to the illumination region. Moreover, in this case, the reflected light may be split by providing a beam splitter in the direction approximately orthogonal to the illumination region.

In the first and second correction methods, the amount of reflectance change is subjected to linear approximation using the two signal levels. However, the actual reflectance change is non-linear as shown in Expression (1). Therefore, the more linear the relationship between the incidence angle and the reflectance, the more accurately the correction can be performed using the first and second correction methods.

In the optical sensor 2245e, since the linearly polarized light is irradiated onto the recording paper, the relationship between the incidence angle and the reflectance can be made more linear compared with the case where non-polarized light is irradiated onto the recording paper. In other words, more accurate correction can be performed compared with the embodiment.

On the surface of the recording paper, the reflectance of s-polarized light is smaller than those of non-polarized light and p-polarized light. In the optical sensor 2245e, since the s-polarized light is irradiated onto the recording paper, the amount of the internal diffuse reflected light is larger than the non-polarized light and the p-polarized light. Accordingly, the S/N ratio of the signal level of the output signal from the photodetector 91 can be improved.

Along with the recent advancement of image forming apparatuses and diversified means of expression, there are over several hundred different types of printing paper, and also there are a wide variety of brands different in specifications such as basis weight and thickness. For high-quality image formation, detailed fixing conditions corresponding to each of the brands need to be set.

Also, there have recently been a growing number of brands regarding plain paper, coated paper typified by gloss coated paper, matt coated paper and art coated paper, plastic sheet, and special paper having an embossed surface.

However, the recording material determination apparatus disclosed in Japanese Patent Application Publication No. 2005-156380 can only determine recording materials different in smoothness, and cannot discriminate between recording materials having the same smoothness and different thicknesses.

The sheet material determination apparatus disclosed in Japanese Patent Application Publication No. Hei 10-160687 and the image forming apparatuses disclosed in Japanese Patent Application Publications Nos. 2006-062842 and Hei 11-249353 can only identify (determine) a difference among non-coated paper, coated paper and OHP sheet, and cannot identify the brand required for high-quality image formation.

The use of the optical sensor 2245e makes it possible not only to discriminate between plain paper and matt coated paper but also to discriminate between multiple brands of plain paper and multiple brands of matt coated paper, by adding recording paper internal information to the recording paper surface information. In short, among multiple types of recording paper different in at least any of gloss, smoothness, thickness and density, the brand of the object can be identified.

Note that the first and second measurement systems may be equivalent to the optical sensor 2245a or the optical sensor 2245b.

Moreover, the internal diffuse reflected light detection system 90 may be added to the optical sensor 2245.

### <Modified Example 6 of Optical Sensor_{>}

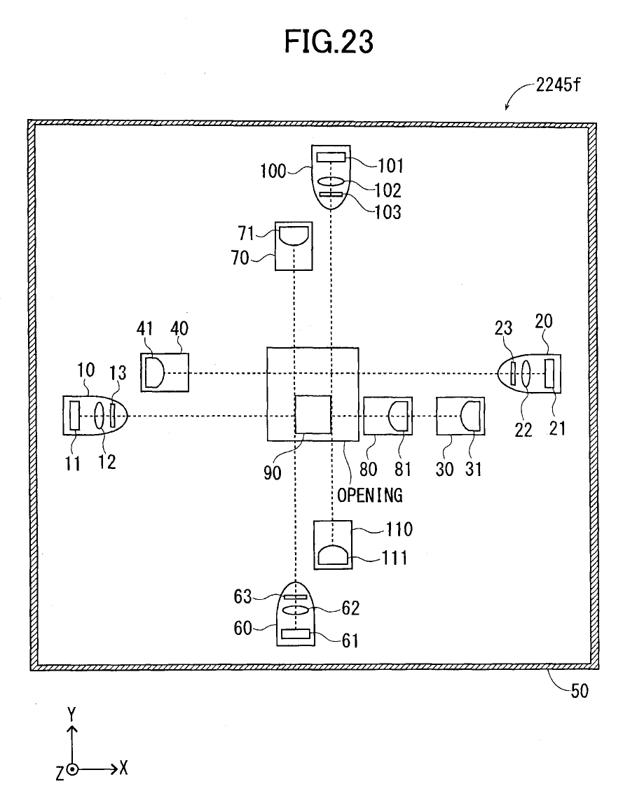

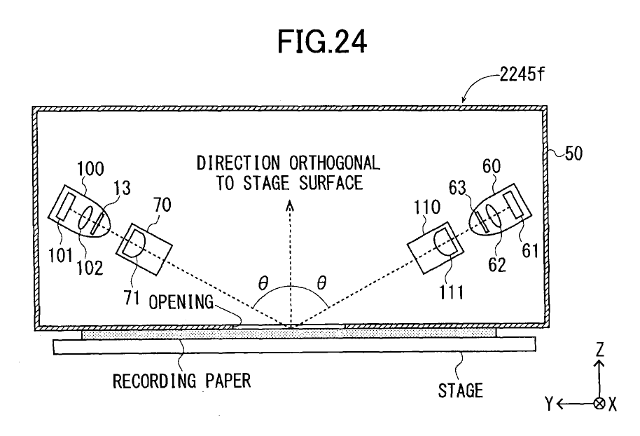

FIGS. 23 and 24 show an optical sensor 2245f of Modified Example 6. This optical sensor 2245f is obtained by adding a fourth illuminating system 100 and a fourth regular reflected light detection system 110 to the optical sensor 2245e. Note that FIG. 24 omits the illustration of the first and second measurement systems, the diffuse reflected light detection system 80 and the internal diffuse reflected light detection system 90 to avoid complication.

The fourth illuminating system 100 includes a light source 101, a collimator lens 102 and a polarization element 103, and disposed at the +Y side of the opening in the dark box 50, and emits light beams toward the opening.

The fourth regular reflected light detection system 110 has a photodetector 111 including a condenser lens, and is disposed on an optical path of a light beam emitted from the fourth illuminating system 100 and regularly reflected by the recording paper.

The multiple light emitting parts of the light source 101 are individually turned on and off by the printer controller 2090. An output signal from the photodetector 111 is sent to the printer controller 2090.

When seen from the Z-axis direction, the fourth illuminating system 100 and the fourth regular reflected light detection system 110 are positioned on the same line extending in the Y-axis direction.

The incidence angle of the irradiation light from the fourth illuminating system 100 relative to the surface of the stage is the incidence angle θ, which is the same as the incidence angle of the irradiation light from the first illuminating system 10, the incidence angle of the irradiation light from the second illuminating system 20 and the incidence angle of the irradiation light from the third illuminating system 60.

Moreover, the area of the illumination region irradiated with the irradiation light from the fourth illuminating system 100 is approximately the same as the area of the illumination region irradiated with the irradiation light from the first illuminating system 10, the area of the illumination region irradiated with the irradiation light from the second illuminating system 20, and the area of the illumination region irradiated with the irradiation light from the third illuminating system 60.

Furthermore, the illumination center of the irradiation light from the fourth illuminating system 100 is set as close as possible to the illumination center of the irradiation light from the first illuminating system 10, and the illumination center of the irradiation light from the second illuminating system 20, and the illumination center of the irradiation light from the third illuminating system 60.

Note that the first and second measurement systems may be equivalent to the optical sensor 2245a or the optical sensor 2245b.

When seen from the Z-axis direction, the third and fourth measurement systems may be arranged in a non-parallel manner.

Also, as in the case of the first and second measurement systems in the optical sensor 2245b, the third and fourth measurement systems may have a beam splitter to split the regular reflected light in front of each illuminating system.

The recording paper is manufactured by flowing in one direction in a manufacturing process. For this reason, the recording paper has orientation of fibers constituting the recording paper, which is called grain. This fiber orientation is formed in the direction in which the recording paper flows in the manufacturing process of the recording paper. Thus, the recording paper may differ in reflection properties depending on the light irradiation direction.

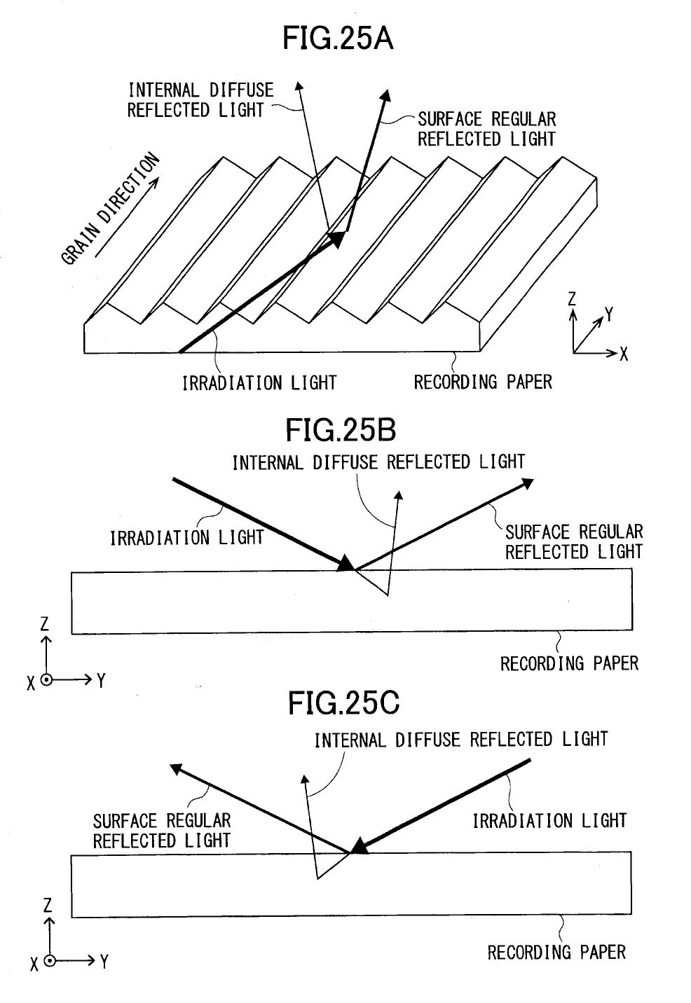

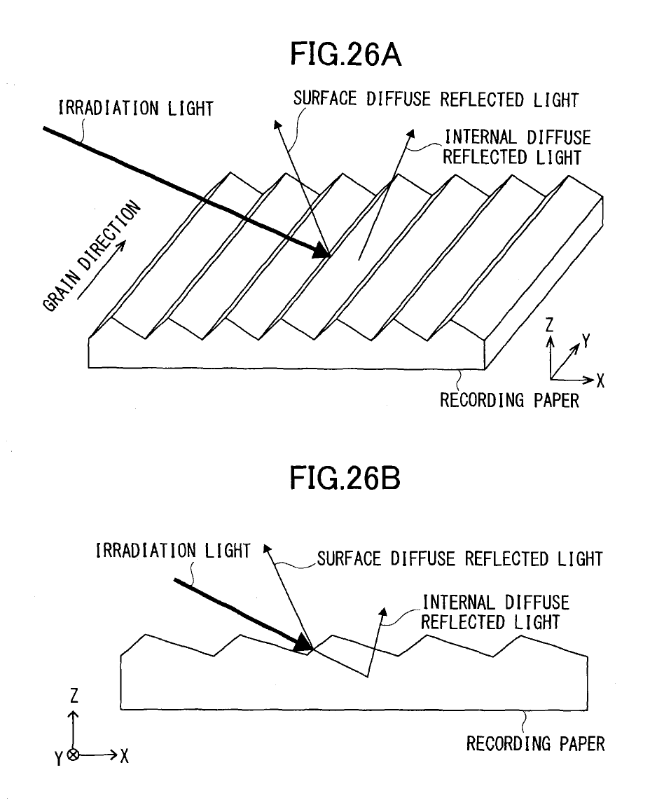

This is described with reference to FIGS. 25A to 26B. In FIGS. 25A to 26B, the recording paper has grain in the Y-axis direction, and has an uneven surface due to the grain.

Here, as shown in FIGS. 25A and 25B, when light is irradiated from a direction parallel to the YZ plane, the surface of the recording paper can be regarded as a smooth flat plane, and most of the irradiation light is regularly reflected by the surface of the recording paper, thus hardly generating surface diffuse reflected light. Moreover, even when the illumination region on the surface of the recording paper is shifted in the Y-axis direction, the amount of surface regular reflected light does not change.

As shown in FIG. 25C, when light is irradiated at the same incidence angle onto the same illumination region as those in FIGS. 25A and 25B, but from a direction rotated 180° around the axis parallel to the Z-axis direction relative to the irradiation light shown in FIGS. 25A and 25B, the amount of surface regular reflected light is the same as that of the case shown in FIGS. 25A and 25B.

Next, as shown in FIGS. 26A and 26B, when light is irradiated from a direction orthogonal to the YZ plane, the surface of the recording paper can be regarded as an uneven surface with slopes, and most of the irradiation light is diffuse-reflected by the surface, thus hardly generating surface regular reflected light. In this case, the amount of surface diffuse reflected light is larger than in the case shown in FIGS. 25A and 25B.

When the illumination region on the surface of the recording paper is shifted in the X-axis direction, the amount of the surface diffuse reflected light is changed depending on the slopes of the illumination region.

When light is irradiated at the same incidence angle onto the same illumination region as those in FIGS. 26A and 26B, but from a direction rotated 180° around the axis parallel to the Z-axis direction relative to the irradiation light shown in FIGS. 26A and 26B, the amount of surface diffuse reflected light is different from that of the case shown in FIGS. 25A and 25B.

In many cases, the recording paper is usually cut and manufactured with the grain direction and the long side direction of the recording paper set to be parallel to each other. Therefore, in the embodiment described above, it is preferable to dispose the optical sensor 2245 in such a manner that the X-axis direction is set at the grain direction on the recording paper. In this case, the output signal from the photodetector 31 and the output signal from the photodetector 41 can be stabilized. Thus, in paper type determination process for the recording paper based on the output signals from the photodetectors 31 and 41, the printer controller 2090 can further accurately perform the paper type determination of the recording paper even if the illumination region is tilted from the reference plane due to deflection, vibration and the like of the recording paper.

The optical sensor 2245f is applicable not only to the recording paper cut in with the grain direction and the long side direction set to be parallel to each other, but also to recording paper cut with the grain direction and the short side direction set to be parallel to each other.

Note that when the uniaxial orientation of irregularities on the surface of the recording paper is not 100%, the optical sensor 2245 is disposed so that the X-axis direction is set at the direction having highest orientation. Thus, the stability of each signal level outputted from the optical sensor 2245 can be increased.

While the description was given of the case where there is one feed tray in the embodiment described above, the present invention is not limited thereto, but more than one feed tray may be provided. In this case, the optical sensor 2245 may be provided for each feed tray.

Moreover, in the embodiment described above, the brand of the recording paper may be specified during conveyance. In this case, the optical sensor 2245 is disposed near a conveyance path. For example, the optical sensor 2245 may be disposed near a conveyance path between a feed roller 2504 and a transfer roller 2042.

The object to be identified by the optical sensor 2245 is not limited to the recording paper.

While the description was given of the case of the color printer 2000 as the image forming apparatus in the embodiment described above, the present invention is not limited thereto, but is applicable to an optical plotter or a digital copier, for example.

Moreover, while the description was given of the case where the image forming apparatus has four photosensitive drums in the embodiment described above, the present invention is not limited thereto.

Furthermore, the optical sensor 2245 and the respective modified examples are also applicable to an image forming apparatus for forming images by spraying ink onto recording paper.

Note that the optical sensors 2245e and 2245f can be applied to object thickness detection. A conventional thickness sensor has a transmission type configuration, and optical systems need to be disposed in both directions across the object. Therefore, a supporting member and the like are required. On the other hand, since the optical sensors 2245c and 2245d detect the thickness only with reflected light, an optical system may be disposed only on one side of the object. Thus, the number of parts can be reduced, and reduction in cost and size can be achieved. Such an optical system is suitable for installation in an image forming apparatus that requires thickness detection of object. The printer controller 2090 may adjust image forming conditions according to the detected thickness.

Furthermore, the optical sensors 2245e and 2245f can be applied to object density detection. A conventional density sensor has a transmission type configuration, and optical systems need to be disposed in both directions across the object. Therefore, a supporting member and the like are required. On the other hand, since the optical sensors 2245c and 2245d detect the density only with reflected light, an optical system may be disposed only on one side of the object. Thus, the number of parts can be reduced, and reduction in cost and size can be achieved. Such an optical system is suitable for installation in an image forming apparatus that requires density detection of object. The printer controller 2090 may adjust image forming conditions according to the detected density.

The optical sensor 2245 and the respective modified examples are also applicable to object smoothness detection. The surface of the recording paper is formed of a flat portion and a tilted portion, and a ratio thereof determines the smoothness of the recording paper surface. Light reflected by the flat portion becomes surface regular reflected light, and light reflected by the tilted portion becomes surface diffuse reflected light. The surface diffuse reflected light is totally scatter-reflected light, and thus can be regarded as having isotropic reflection direction. The higher the smoothness, the more the amount of the surface regular reflected light. The printer controller 2090 may adjust image forming conditions according to the detected smoothness.

The optical sensor 2245 and the respective modified examples are also applicable to object tilt angle detection.

Although the preferred embodiments of the present invention have been described, it should be understood that the present invention is not limited to these embodiments, various modifications and changes can be made to the embodiments.

What is claimed is:

1. An optical sensor comprising:
a first illuminating system for emitting light to a surface of an object from a first direction;
a second illuminating system for emitting light to the surface of the object from a second direction different from the first direction;
a first regular reflected light receiving system for receiving light emitted from the first illuminating system and regularly reflected by the object; and
a second regular reflected light receiving system for receiving light emitted from the second illuminating system and regularly reflected by the object,
wherein the object is placed on a flat surface, and
incidence angles of the light emitted from the first and second illuminating systems relative to the flat surface are equal to each other.

2. The optical sensor according to claim 1, further comprising:
a third illuminating system for emitting light to the surface of the object from a third direction different from the first and second directions; and
a third regular reflected light receiving system for receiving light emitted from the third illuminating system and regularly reflected by the object,
wherein the incidence angle of the light emitted from the third illuminating system relative to the flat plane is equal to the incidence angles of the light emitted from the first and second illuminating systems relative to the flat plane.

3. The optical sensor according to claim 1, wherein
the centers of regions in the object illuminated by the light from the illuminating systems are the same.

4. The optical sensor according to claim 1, further comprising:
a diffuse reflected light receiving system for receiving light emitted from the first illuminating system and diffuse-reflected by the object.

5. The optical sensor according to claim 1, wherein
the first illuminating system emits linearly polarized light in a first polarization direction,
the optical sensor further comprising:
a diffuse reflected light detection system including an optical element disposed on an optical path of light diffuse-reflected by the object within an incidence plane of the object and transmitting linear polarization components in a second polarization direction orthogonal to the first polarization direction, and a photodetector for receiving light transmitted through the optical element.

6. The optical sensor according to claim 5, wherein
the first polarization direction is parallel to the flat plane.

7. The optical sensor according to claim 6, wherein
the diffuse reflected light detection system is disposed on an optical path of light diffuse-reflected in a normal direction to the flat plane.

8. The optical sensor according to claim 1, wherein
each of the illuminating systems includes a surface-emitting laser array having a plurality of light emitting parts.

9. An image forming apparatus for forming an image on a recording medium, comprising:
the optical sensor according to claim 1 using the recording medium as an object.

10. A method for determining a type of paper placed on a flat plane using the optical sensor according to claim 1, the paper having grain in one direction, comprising:
setting a position of at least one of the paper and the optical sensor so that the travelling directions of the light emitted from the first and second illuminating systems in the optical sensor are parallel to the one direction when seen from a direction orthogonal to the flat plane;
emitting light from the first and second illuminating systems; and
determining a type of the paper based on output signals from the first and second regular reflected light receiving systems in the optical sensor.
